(19) United States
(12) Patent Application Publication
(10) Pub. No.: US 2011/0080588 A1
(43) Pub. Date: Apr. 7, 2011

(54) NON-CONTACT LASER INSPECTION SYSTEM

(75) Inventor: Stephen Barrett Segall, Ann Arbor, MI (US)

(73) Assignee: INDUSTRIAL OPTICAL MEASUREMENT SYSTEMS, ANN ARBOR, MI (US)

(21) Appl. No.: 12/879,245

(22) Filed: Sep. 10, 2010

Related U.S. Application Data
(60) Provisional application No. 61/248,244, filed on Oct. 2, 2009.

(51) Int. Cl. G01N 21/55

(52) U.S. Cl. 356/445

(57) ABSTRACT

A non-contact laser inspection system includes a probe with a thin tubular extension into which a light redirecting mechanism is incorporated to permit inspection of small diameter cylinders. The laser inspection system contains a laser that produces a beam of light that is coincident with an axis of the probe body. A reflector in the tip of the probe deflects the laser beam perpendicular to the axis of the probe. An optical system in the probe directs directly back reflected light to a detector contained in the probe body. The probe is mounted in a rotatable shaft and the axis of the probe is aligned along the axis of the rotatable shaft. The rotatable shaft rotates the probe as it is inserted into a cylindrical hole, so the laser beam can scan the inside of the cylindrical surface.

### CROSS-REFERENCE TO RELATED APPLICATIONS

This application claims the benefit of U.S. Provisional Application No. 61/248,244 filed on Oct. 2, 2009. The disclosure of the above application is incorporated herein by reference.

### FEDERALLY SPONSORED RESEARCH

Certain of the research leading to the present invention was sponsored by the United States Government under National Science Foundation Grant IIP-0924053. The United States Government may have certain rights to the invention.

### FIELD

The present disclosure relates to non-contact laser inspection systems and more particularly to non-contact laser inspection systems for detection of surface defects on reflective cylindrical or conical parts.

### BACKGROUND

Adequate inspection of parts in a manufacturing process is desirable in order to meet part tolerances, minimize scrap and prevent defective components from being incorporated into larger subsystems. Rapid detection of defects under conditions of high volume manufacture is particularly important. If a defective part is incorporated into a larger system, the cost of disassembling the system, identifying the defect and replacing the defective part can dramatically increase production costs. Therefore, rapid detection of defects before system integration is desirable.

If parts can be inspected at the speed of a production line it may be possible to use this information for process control. If it appears that parts are drifting out of tolerance, corrective action could be taken so that defective parts are not produced. Sudden onset defects in a production system could be identified before large quantities of scrap are produced.

Some common surface defects on machined surfaces may occur randomly. These include pores, chips, and scratches. Poured metal castings contain entrained air bubbles around which liquid metal can solidify. When the castings are machined these bubbles can be cut open and exposed as pores. Chips may form when pieces of metal chip off from a casting as a tool enters or exits a hole in a part. Scratches on a surface may also make a component defective. These types of defects can be difficult to detect when they occur inside cylindrical holes in a part.

Complex parts, such as valve ports of automatic transmissions, may contain cylindrical holes that may vary progressively in diameter in discrete steps along the length of the cylinder. The cylinders may also be intersected by multiple slots. Valve ports may vary between about 8 to 24 millimeters in diameter and may have lengths over 100 millimeters. Defects in valve ports over areas as small as 0.1 mm² may cause problems or failure when used in automobile transmissions. Defects in such complex parts can be particularly difficult to detect rapidly with existing probes and sensors.

Non-contact gauges of various types are used to measure dimension and surface defects using optical, capacitive, eddy current and Hall-effect sensors. Most of these gauges do not measure surface finish. Imaging systems may measure geometry and surface finish, but they typically require image analysis software which may be quite slow. In addition, some geometries do not lend themselves easily to insertion of existing gauges.

Contact gauges are also used to measure dimensional accuracy and surface roughness. These gauges include coordinate measuring machines of various types and stylus gauges. Stylus gauges measure surface roughness by tracing a thin line with a diamond-tipped needle. The thin line is an extremely small fraction of the total surface area. The measurement is slow and may miss defective regions. If there are gaps in the surface, the stylus tip must be raised to avoid these gaps and avoid damage to the tip of the needle. Such characteristics make stylus gauges impractical for total part inspection on a production line.

A number of optical instruments used to detect surface flaws on reflective surfaces illuminate the surface with a directed source of illumination and place a detector in a location that will not detect specularly reflected light. Instead, the detector is generally placed to detect light scattered by a defect. If there is no defect, no signal will be received by the detector, but if there is a defect that scatters light, a signal will be received by the detector. Examples of scattered light detectors are given in U.S. Pat. Nos. 6,097,482 and 7,372,557.

Scattered light detection may be adequate when it is possible to position the light source and detector at different viewing angles that prevent reflected light from reaching the detector. However, for small diameter cylindrical holes this may not be practical or possible.

Another approach to surface defect detection uses a diffuse beam of light to illuminate a surface and a camera or other imaging system to image the surface. The data must then be analyzed using image analysis software. Examples of this type of inspection system are given in U.S. Pat. Nos. 7,394,530, 6,516,083, 6,169,600, 5,588,068, 5,353,357, and 4,732,474. In general, the illumination system and detection path are not coincident and this approach is therefore not suitable for inspecting small diameter cylinders with lengths significantly longer than the cylinder diameter.

Another technique that can inspect the inside of relatively small diameter cylinders is a confocal microscope, such as one that is commercially available from the Micro-Epsilon Corporation. This system can scan the inside of a cylinder with a focused beam of light. However, the focal spot on the surface of the cylinder is so small that a considerable time is required to scan the total area of a cylinder.

Accordingly, there is a need in the art for an improved non-contact laser inspection system capable of rapidly detecting surface defects and inspecting small diameter bores.

### SUMMARY

This disclosure relates to an instrument and method for the rapid inspection of reflective surfaces of cylindrical parts for surface finish defects in a high volume production environment. A non-contact laser system uses an optical configuration in which a laser beam is directed substantially perpendicular to the surface to be inspected. Some of the laser beam light is back reflected along the trajectory of the incident beam. This makes it possible to use the detector to detect surface defects in small diameter cylindrical holes including cylinders in which the hole depth is much larger than the hole diameter. Using this system a reflective surface with no defects will produce a large optical return signal. Conversely, surface defects that scatter the incident beam will result in a dip in the return light intensity.

One embodiment of the present disclosure includes a laser probe with a thin tubular extension or tip into which a light redirecting mechanism is incorporated to permit inspection of small diameter cylinders. The probe contains a laser that produces a beam of light that is coincident with an axis of the tubular extension. A reflector in the tubular extension of the probe deflects the laser beam substantially perpendicular to the surface of the cylindrical or conical part being inspected. An optical system in the probe directs directly-back-reflected and directly back scattered light to a detector contained in the probe body. The probe body also contains electronics to amplify the detector signal. A slip ring mounted on the probe shaft permits electric power to be input to the probe and data to be retrieved while the probe is spinning. The probe is mounted on a rotatable shaft and the axis of the probe is aligned along an axis of the rotatable shaft. The rotatable shaft rotates the probe as it is inserted into a cylindrical or conical hole, so the laser beam can scan the inside of the cylindrical or conical surface. Linear and rotary encoders monitor the probe axial and angular positions. Data from the probe and from the encoders are collected using a data acquisition system and the data is analyzed and displayed using a computer and analysis and display software.

In another aspect of the present disclosure, an inspection probe for inspecting reflective cylindrical or conical surfaces of manufactured components is provided. The probe includes a laser system, an optical system, an optical detector, and a computer. The optical system directs a laser beam perpendicular to the surface being inspected and directs back-reflected light to an optical detector. The optical detector detects the back-reflected laser light from the surface.

In yet another aspect of the present disclosure, the computer includes software that compares the detected light signal to a light signature from a known cylindrical or conical surface or cylindrical or conical surface with known defects and determines a condition of the surface.

In yet another aspect of the present disclosure, the probe further includes a filter in front of the detector to reduce unwanted light.

In yet another aspect of the present disclosure, the reflective cylindrical surface is one of a valve port of a valve body or pump cover of an automatic transmission, a brake cylinder, a cylindrical reflective surface of a component of a shock absorber, the surface of a hydraulic or pneumatic cylinder, the inside surface of a gas flow valve, the inside or outside surface of a reflective cylindrical manufactured part, or a component with a tapped interior thread.

In yet another aspect of the present disclosure, the laser system, the optical system, and the detector are mounted inside a support structure.

In yet another aspect of the present disclosure, the support structure is mounted on a support shaft.

In yet another aspect of the present disclosure, the support shaft is mounted in the spindle of a machine.

In yet another aspect of the present disclosure, the laser beam is aligned along an axis of the spindle.

In yet another aspect of the present disclosure, the optical system includes an optional beam reducer to reduce the diameter of the parallel laser beam emitted along an axis of the spindle.

In yet another aspect of the present disclosure, the laser beam is reflected by an optical reflector in a direction perpendicular to the cylindrical surface to be measured.

In yet another aspect of the present disclosure, the optical system directs the return beam from the cylindrical surface onto a detector.

In yet another aspect of the present disclosure, the optical system includes a polarizing beam splitter, a quarter wave plate, an optional spacer and a 90° reflector, such as a right angle prism.

In yet another aspect of the present disclosure, the polarizing beam splitter, the quarter wave plate, the optional spacer, and the 90° reflector are attached together to form a single rigid component.

In yet another aspect of the present disclosure, the optical detector is a photodiode.

In yet another aspect of the present disclosure, the probe includes a device transmitting power to the laser and electronics in the detector and transmitting data to a computer.

In yet another aspect of the present disclosure, the power and data transmitting device is mounted on the support shaft.

In yet another aspect of the present disclosure, the power and data transmitting device is a slip ring.

In yet another aspect of the present disclosure, the probe includes a detector electronics device mounted in the support structure.

In yet another aspect of the present disclosure, the detector electronics device includes signal amplification.

In yet another aspect of the present disclosure, the shaft is rotatably supported on a chuck or tool holder.

In yet another aspect of the present disclosure, the chuck or tool holder is supported on a spindle.

In yet another aspect of the present disclosure, the spindle is supported in a computer numerically controlled (CNC) machine or robot.

In yet another aspect of the present disclosure, the CNC machine or robot is programmed to rotate and insert the probe into a reflective cylindrical component of a manufactured part.

In yet another aspect of the present disclosure, the laser beam scans the surface of the cylindrical part.

In yet another aspect of the present disclosure, the CNC machine or robot has axial and rotary encoders to determine axial position and rotation angle of the probe in the cylinder.

In yet another aspect of the present disclosure, the data acquisition system of the computer records the angular position of data points measured by the probe.

In yet another aspect of the present disclosure, data from the linear encoder is recorded by the data acquisition system.

In yet another aspect of the present disclosure, a method for inspecting a machined surface is provided. The method includes the steps of: directing a laser beam perpendicularly to the machined surface, detecting a back-reflected laser beam from the machined surface, determining a signature of the detected laser beam light, and determining a condition of the machined surface from the signature.

In yet another aspect of the present disclosure, the machined surface is a cylinder.

In yet another aspect of the present disclosure, determining a signature includes comparing a light signature from a known surface or surface with known defects to the light signature from the inner surface of the cylinder.

Further areas of applicability will become apparent from the description provided herein. It should be understood that the description and specific examples are intended for purposes of illustration only and are not intended to limit the scope of the present disclosure.

### DRAWINGS

FIG. 1 is a schematic drawing of an inspection system in an operating environment in accordance with the principles of the present disclosure;

FIG. 2 is a cross sectional view of an exemplary laser probe in accordance with the principles of the present disclosure;

FIG. 3 is a cross sectional view of an exemplary laser probe in accordance with the principles of the present disclosure;

FIG. 4 is a flow chart of a method for inspecting a bore according to the principles of the present disclosure; and

FIG. 5 is a schematic drawing of an inspection system in an operating environment in accordance with the principles of the present disclosure.

### DETAILED DESCRIPTION

The following description is merely exemplary in nature and is not intended to limit the present disclosure, application, or uses. It is to be understood that standard components or features that are within the purview of an artisan of ordinary skill and do not contribute to the understanding of the various embodiments of the invention are omitted from the drawings to enhance clarity. In addition it will be appreciated that the characterization of various components and orientations described herein as being “vertical” or “horizontal”, “right” or “left”, “side”, “top” or “bottom” are relative characterizations only based upon the particular position or orientation of a given component for a particular application.

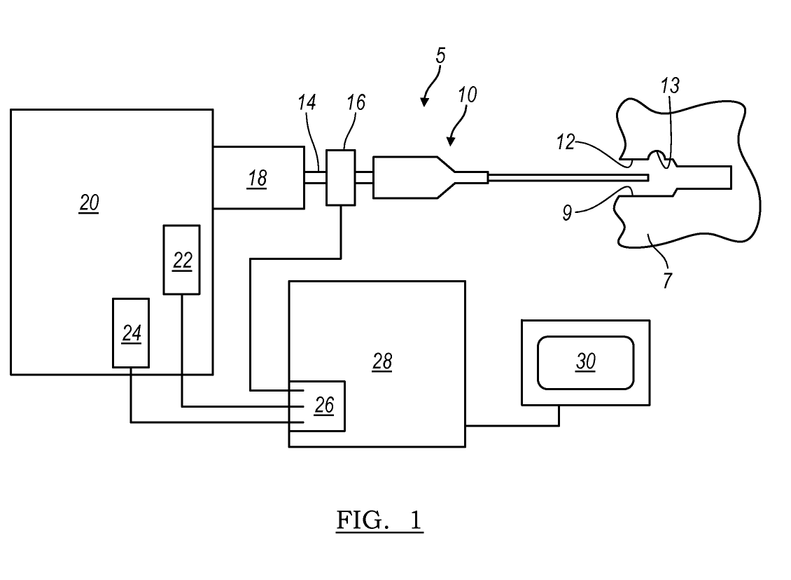

With reference to FIG. 1, a schematic diagram of inspection system 5 for inspecting workpiece 7 is shown. Inspection system 5 includes a probe 10, probe shaft 14, slip ring 16, rotatable shaft 18, positioning machine 20, rotary encoder 22, linear encoder 24, data acquisition unit 26, computer 28, and monitor 30.

Workpiece 7 includes an at least partially reflective inner surface 9 that defines at least one bore 12. In the example provided, bore 12 is a valve port and workpiece 7 is a valve body or pump cover in a transmission of an automobile.

However, it should be appreciated that cylindrical bore 12 could exist in many other types of workpieces 7, such as, but not limited to, brake cylinders, shock absorbers, hydraulic or pneumatic cylinders, gas flow valves, tapped internally threaded cylinders or other cylindrical manufactured parts.

In the example provided, inner surface 9 includes surface defect 13. However, it should be appreciated that surface defect 13 may not be present in a given bore 12, or many surface defects 13 may be present in a given bore 12. In addition, bore 12 may have other diameters, depths, types of defects 13, and numbers of defects 13 without departing from the scope of the present disclosure.

Probe 10 is disposed in bore 12. Probe 10 is generally a laser probe, as will be described below. Probe 10 is attached to and centered on probe shaft 14.

In the example provided, slip ring 16 is mounted on probe shaft 14 and is electrically connected to the components of probe 10, as will be described in detail below.

Probe shaft 14 is mounted to rotatable shaft 18 of positioning machine 20. Positioning machine 20 rotates and axially moves rotatable shaft 18. Rotatable shaft 18 may be a solid bar or a hollow tube. In the example provided, positioning machine 20 is a computer numerically controlled (CNC) machine, and probe shaft 14 is mounted in a chuck (not shown) of rotatable shaft 18. However, it should be appreciated that other positioning machines 20 capable of rotating probe 10 may be used without departing from the scope of the present disclosure. Standard machining techniques may be used to align the center of probe 10 with the axis of rotatable shaft 18. The positioning machine 20 includes rotary encoder 22 and linear encoder 24 that indicate the angular orientation and the axial position of rotatable shaft 18 in the machining system. Rotatable shaft 18 and a portion of positioning machine 20 are commonly known in industry as a spindle.

Data acquisition unit 26 may be an internal data acquisition card installed in computer 28 or an external data collection unit in communication with computer 28. However, other types of devices that perform the same functions as computer 28 may be employed without departing from the scope of the present invention. Data acquisition unit 26 is in communication with rotary encoder 22 and linear encoder 24. In an alternative embodiment where bore 12 may be scanned without linear position data, data acquisition unit 26 is not in communication with linear encoder 24.

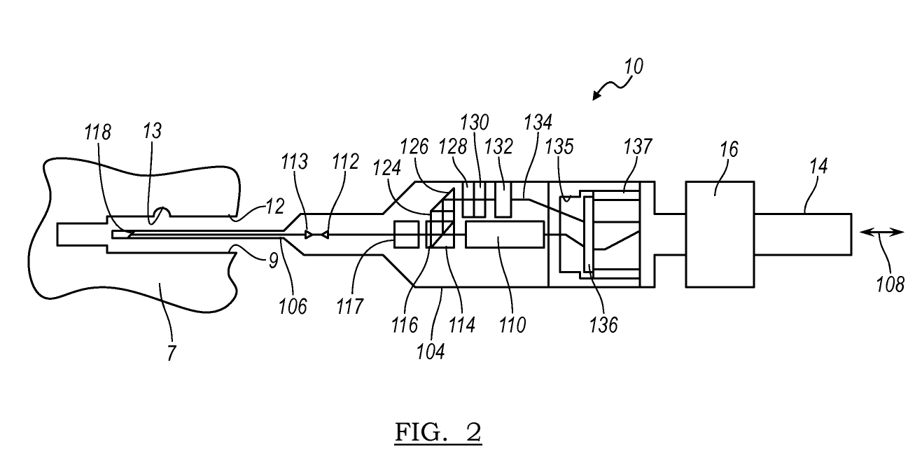

Turning to FIG. 2, further details of probe 10 are shown. Probe 10 has body portion 104 and tip portion 106 extending from body portion 104 and partially disposed within bore 12. Body portion 104 and tip portion 106 are preferably cylindrically shaped for improved balance during rotation. The interior of body portion 104 is preferably shaped for easy insertion and removal of optic and electronic components and may be covered by a removable outer envelope (not shown) to access the interior of body portion 104. In the example provided, tip portion 106 is a thin walled-tube about 100 millimeters in length with an outer diameter of about 3.9 millimeters. However, other shapes, diameters and lengths may be employed without departing from the scope of the present disclosure. Body portion 104 and tip portion 106 are centered along a common axis 108. Laser 110 is mounted in body portion 104 and is aligned to emit laser beam 112 through tip portion 106 along axis 108. Preferably, laser beam 112 has a diameter of about 1 mm. In the example provided, an optional aperture or other type of beam reducer 117 can reduce the diameter of laser beam 112 to less than 1 mm before laser beam 112 enters tip portion 106. Laser beam 112 may return substantially along axis 108 towards laser 110 as return beam 113. Laser beam 112 has a predetermined polarization that interacts with other components in desirable ways, as will be described below. Proper polarization of laser beam 112 may be achieved by rotational alignment of laser 110. In the example provided, laser 110 is a diode laser that fits loosely into a cylindrical cavity in probe body 104 and can be aligned using six set screws (not shown) to both center laser 110 in probe body 104 and align laser beam 112 along probe axis 108. Apertures and interior surfaces that may scatter light into detector 132 are made of black material or are coated black to absorb the scattered light. Tapped threads may also be added to some interior cylindrical surfaces of probe body 104 to enhance absorption of scattered light.

Polarizing beam splitter 114 is disposed on axis 108 between laser 110 and tip portion 106. Laser 110 is oriented so that the polarization of laser beam 112 allows laser beam 112 to pass through polarizing beam splitter 114 substantially undeflected. Polarizing beam splitter 114 deflects return beam 113 due to the polarization of return beam 113, as will be described below. Polarizing beam splitter 114 preferably deflects return beam 113 perpendicular to axis 108.

Quarter wave plate 116 is also disposed on axis 108 between polarizing beam splitter 114 and tip portion 106. Quarter wave plate 116 is oriented to convert the polarization of laser beam 112 from linear polarization to circular polarization. Quarter wave plate 116 also converts the polarization of return beam 113 from circular polarization to linear polarization, but in a direction that is perpendicular to the original linear polarization of laser beam 112. Beam reducer 117 is disposed between quarter wave plate 116 and tip portion 106.

Mirror 118 is disposed in and rotates with tip portion 106 on axis 108. Preferably, mirror 118 is disposed near an end of tip portion 106 farthest from body portion 104. Mirror 118 may be a separate reflector attached to probe tip 106, and may be a cut and polished glass rod with a diameter of about 2 to 3 mm. However, other types, shapes and diameters of mirror 118 may be used without departing from the scope of the present disclosure. Mirror 118 is angled to deflect laser beam 112 perpendicular to inner surface 9 of workpiece 7. In the example provided, mirror 118 is generally angled at 45 degrees with respect to axis 108.

In an alternative embodiment, mirror 118 is at a different angle with respect to axis 108 in order to inspect conical surfaces, such as the sealing surface of a valve seat of an engine head. The deflection angle of mirror 118 is preferably chosen to deflect laser beam 112 perpendicular to the specified conical surface. If the surface has been machined at the specified angle, the back reflected light will produce a large signal at the detector. If the conical angle of the valve seat is incorrect or the valve seat is misaligned or defective there will be a lower detector signal.

In an alternative embodiment of a probe, a fiber optic cable (not shown) is disposed in a probe to transmit beams 112 and 113. A laser insertion assembly (not shown) is disposed at an end of the fiber optic cable to insert laser beam 112 into the fiber optic cable. A light collimating assembly is disposed at a second end of the fiber optic cable to collimate the light from laser beam 112 exiting the fiber optic cable. Mirror 118 at the end of tip portion 106 may be used to deflect laser beam 112 perpendicular to surface 9 of bore 12. However, other types of deflection assemblies may be used at the end of tip portion 106 to deflect laser beam 112 perpendicular to surface 9 of bore 12.

In the example provided, optional glass spacer 124 is disposed adjacent polarizing beam splitter 114 in the path of return beam 113. Alternatively, an opaque spacer with a centered clear aperture could be used in place of the glass spacer 124.

Right angle prism 126 is disposed adjacent to glass spacer 124 and in the path of return beam 113 after return beam 113 has been deflected by polarizing beam splitter 114. Right angle prism 126 is oriented to deflect return beam 113 in a direction substantially parallel to axis 108.

In the example provided, wavelength filter 128 and neutral density filter 130 are disposed adjacent right angle prism 126. However, in an alternative embodiment, neutral density filter 130 may be omitted, and wavelength filter 128 may be omitted when the only potential source of light reaching detector 132 is generated by laser 110.

In the example provided, polarizing beam splitter 114, quarter wave plate 116, glass spacer 124, and right angle prism 126 are held rigid by an index matching epoxy. However, the components may be held rigid in other ways without departing from the scope of the present disclosure. Preferably, any optical surface in contact with air is coated to reduce reflection.

Detector 132 is disposed adjacent neutral density filter 130 in the path of return beam 113. Detector 132 is generally a photodiode that converts optical signals to electrical signals. However, other types of detectors 132 may be used without departing from the scope of the present disclosure.

Electrical cable 134 connects detector 132 with electronic circuit 136. In the example provided, electronic circuit 136 is held in place by a lip at the bottom of a cavity 135 and thin collar 137 within probe body 104. However, electronic circuit 136 may be placed in other locations and fixed within probe body 104 in other ways without departing from the scope of the present disclosure.

Probe body 104 is attached to probe shaft 14 by screws (not shown). Probe shaft 14 has a hole (not shown) through its center and a hole perpendicular to axis 108 proximate slip ring 16. The hole through the center can enable clean low pressure compressed air to flow through the probe body and tip to create a positive pressure shielding the optical and other internal components from the outside environment. Wiring from laser 110 and wires from circuit board 136 pass through the hole perpendicular to axis 108 in probe shaft 14 and are connected to slip ring 16. A cable (not shown) from slip ring 16 is connected to data acquisition unit 26 in computer 28. Power cables (not shown) connect to a power supply (not shown), providing power to probe 10.

With combined reference to FIGS. 1 and 2, the operation of inspection system 5 will now be described. During operation, positioning machine 20 will spin probe 10 as probe 10 enters bore 12. For a smooth cylindrical inner surface 9, much of laser beam 112 will be reflected directly back on itself as return beam 113. If a surface defect 13 is present, at least some of laser beam 112 will scatter and not be reflected as return beam 113. Thus, the intensity of return beam 113 may be used to indicate the presence of surface defect 13.

Laser beam 112 is emitted by laser 110 through polarizing beam splitter 114, quarter wave plate 116 and beam reducer 117, and is redirected towards inner surface 9 of workpiece 7 by mirror 118. Upon reaching inner surface 9, part of laser beam 112 is back reflected along the path of incident laser beam 112. If surface defect 13 is present, at least part of laser beam 112 will not be reflected as return beam 113. When at least part of laser beam 112 does not reflect back, any return beam 113 that does return will have lower intensity than when there is no surface defect 13. Return beam 113 is reflected by mirror 118 through beam reducer 117 (which now may act as a beam expander) towards quarter wave plate 116. Quarter wave plate 116 converts return beam 113 polarization so that polarizing beam splitter 114 redirects return beam 113 through spacer 124 to right angle prism 126. Right angle prism 126 directs return beam 113 through wavelength filter 128 and neutral density filter 130 to detector 132. When employed, neutral density filter 130 reduces return beam 113 intensity to prevent saturation of the electronic circuit 136 or data acquisition unit 26, and wavelength filter 128 reduces the intensity of a portion of the return light corresponding to certain wavelengths. Detector 132 converts the intensity of return beam 113 into an electrical signal and sends the electrical signal through electrical cable 134 to electronic circuit 136. Electronic circuit 136 sends a signal indicative of the intensity of return beam 113 through slip ring 16.

Data from probe 10 is transmitted through slip ring 16 to data acquisition unit 26 in computer 28. Data from rotary encoder 22 is also sent to data acquisition unit 26. When a pulse is received from rotary encoder 22, data acquisition unit 26 samples the value of the signal from probe 10. Data from linear encoder 24 may also be sent to data acquisition unit 26 to indicate the axial location at which data from probe 10 is being sampled.

Computer 28 preferably analyzes the data from probe 10, rotary encoder 22, and linear encoder 24. Preferably, software in computer 28 may create a three dimensional graph of probe 10 data as a function of position, representing surface 9 of bore 12. The results of the analysis may be displayed on monitor 30. The graph displayed on monitor 30 is provided to assist human visualization of surface 9 of bore 12. The software in computer 28 obtains the information used to generate the graph and analyze the data from a data file created from data transmitted to computer 28 by data acquisition unit 26. Alternatively, the software in computer 28 analyzes the data from data acquisition unit 26 and provides information about whether a part is acceptable or defective without generating a graph.

In an alternative embodiment, a probe is configured to inspect the outside surface of cylinders, cones, or gears by rotating the part (not shown) rather than the probe. In this embodiment, the probe does not rotate and slip ring 16 is not included because it is not needed to transmit power to and collect data from the probe. Deflecting mirror 118 may be omitted and laser beam 112 can be directed along axis 108 directly to the part being inspected. A machine (not shown) rotates the part, and has a means of determining the axial position of the probe and rotational position of the part and transmitting this information to data acquisition unit 26 collecting data from the probe. In addition to rotating the part being inspected, the machine also moves the probe linearly relative to the rotating part or moves the rotating part linearly relative to the probe in order to scan the surface of the rotating part.

The diameter of bore 12 may be determined by measuring the average intensity of return beam 113. Smaller diameter bores 12 may have lower average return beam intensities because part of the edges of laser beam 112 may be reflected away from probe 10 due to the small radius of curvature of bore 12.

The data obtained from probe 10 may be compared with data from a master bore known to be free of defects. The workpiece 7 can be removed for further inspection if the data between the master bore and the bore 12 of the workpiece 7 deviate from each other by a predetermined amount.

In an alternative embodiment of a probe, slip ring 16 is mounted on a second shaft (not shown). The second shaft is co-axial with and mounted to rotatable shaft 18 and is disposed on the side of rotatable shaft 18 opposite probe shaft 14. A cable (not shown) is disposed in a bore (not shown) of rotatable shaft 18 to connect slip ring 16 with the probe. Mounting slip ring 16 on the second shaft improves the load balance on rotatable shaft 18 when the probe is mounted horizontally. Rotary encoder 22 can also be connected to the second shaft. It should be appreciated that the hole perpendicular to axis 108 in shaft 14 of the probe may be omitted. In the example provided, there is a hole on the second shaft perpendicular to axis 108.

In an alternative embodiment of a probe, slip ring 16 is omitted and data is transmitted wirelessly from the probe to data acquisition unit 26. An example of wireless data transmission adapted for use in the probe is given in a paper by C. Suprock, et al. titled “A Low Cost Wireless Tool Tip Vibration Sensor for Milling” in the Proceedings of the International Manufacturing Science and Engineering Conference (MSEC2008).

The data from probe 10 may also be used to determine whether axis 108 of probe 10 and an axis defined by bore 12 are coincident. If probe 10 is off center relative to the bore axis, the signal from probe 10 may be modulated with the period of the probe rotation. This modulation may be filtered out when the data is analyzed. The data may also be used as a diagnostic to monitor the relative alignment of probe 10 within bore 12.

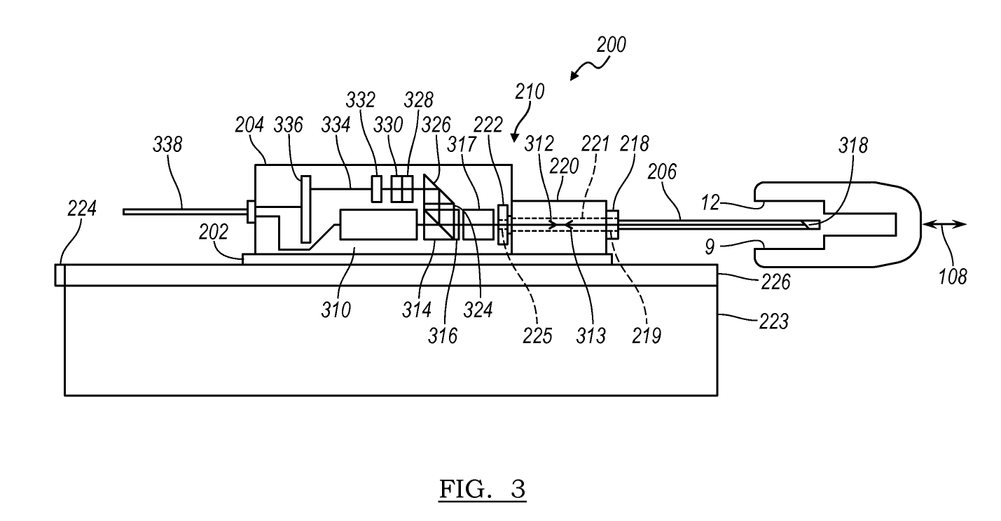

Another alternative embodiment that does not include a slip ring is shown in FIG. 3, which shows a schematic diagram of inspection system 200 for inspecting workpiece 7. Inspection system 200 includes probe 210, base 202, probe cover and body portion 204, probe tip 206, rotatable shaft 218, rotation machine 220, linear movement machine 223, rotary encoder 222, and linear encoder 224. Rotatable shaft 218, rotation machine 220 and rotary encoder 222 may be combined into a spindle with integral rotary encoder. Probe 210 is generally a laser probe, as will be described below. Base 202 is designed to properly position the optical and electronic components and slide along rail 226 of linear movement machine 223.

Body portion 204 does not rotate and is rigidly mounted on and moves linearly with base 202. The interior of body portion 204 is preferably shaped for easy insertion and removal of optic and electronic components. In the example provided, body portion 204 includes a removable outer envelope that allows access to the optic and electronic components when removed. The outer envelope of body portion 204 prevents stray light from reaching the optical components, protects the probe components from the outside environment and permits low pressure compressed air to flow through probe 210.

Probe tip 206 may be attached to rotary shaft 218 with a chuck, tool holder, or collet (not shown). Probe tip 206 is rigidly held in rotatable shaft 218, is rotatable with rotatable shaft 218 and is disposed in bore 12. Probe tip 206 is centered on axis 308. Probe tip 206 is preferably cylindrically shaped for improved balance during rotation. In the example provided, tip portion 206 is a thin walled-tube about 100 millimeters in length with an outer diameter of about 3.9 millimeters. However, other shapes, diameters and lengths may be employed without departing from the scope of the present disclosure.

Rotatable shaft 218 is centered on axis 308 and is rotatable by rotation machine 220. Rotatable shaft 218 includes a clear through aperture 219 through an axial dimension of rotatable shaft 218 aligned with axis 308. Rotation machine 220 is rigidly mounted on base 202, does not rotate, and moves with base 202 along an axis of linear machine 223. Rotation machine 220 includes aperture 221 that surrounds rotatable shaft 218 and extends through rotation machine 220 substantially along axis 308. Rotatable shaft 218 and rotation machine 220 may be integrated into a spindle, and rotatable shaft 218 may be disposed within aperture 221. Rotation machine 220 includes rotary encoder 222 that indicates the angular orientation of rotatable shaft 218 in inspection system 200. In the example provided, rotary encoder 222 is aligned with rotatable shaft 218, and includes aperture 225 that extends through rotary encoder 222 substantially along axis 308. However, rotary encoder 222 may be placed in other locations in which case aperture 225 may be omitted without departing from the scope of the present disclosure.

Linear movement machine 223 includes linear encoder 224 and guide rail 226. Guide rail 226 constrains movement of base 202 to linear movement along the length of guide rail 226. Linear encoder 224 indicates the linear location of base 202 and probe tip 206 in inspection system 200. In the example provided, linear movement machine 223 is a CNC machine. However, other machines may be used without departing from the scope of the present disclosure.

Laser 310 is mounted in body portion 204 and is aligned to emit laser beam 312 through tip portion 206 along axis 308. Preferably, laser beam 312 has a diameter of about 1 mm. In the example provided, an aperture or other type of beam reducer 317 reduces the diameter of laser beam 312 before laser beam 312 enters tip portion 206. In an alternative embodiment, beam reducer 317 is omitted. Laser beam 312 may return substantially along axis 308 towards laser 310 as return beam 313. Laser beam 312 has a predetermined polarization that interacts with other components in desirable ways, as will be described below.

Polarizing beam splitter 314 is disposed on axis 308 between laser 310 and tip portion 206. Laser 310 is oriented so that the polarization of laser beam 312 allows laser beam 312 to pass through polarizing beam splitter 314 substantially undeflected. Polarizing beam splitter 314 deflects return beam 313 due to the polarization of return beam 313, as will be described below. Polarizing beam splitter 314 preferably deflects return beam 313 perpendicular to axis 308.

Quarter wave plate 316 is also disposed on axis 308 between polarizing beam splitter 314 and tip portion 206. Quarter wave plate 316 is oriented to convert the polarization of laser beam 312 from linear polarization to circular polarization. Quarter wave plate 316 also converts the polarization of return beam 313 from circular polarization to linear polarization, but in a direction that is perpendicular to the original linear polarization of laser beam 312. Beam reducer 317 is disposed between quarter wave plate 316 and tip portion 206. Beam reducer 317 may act as a beam expander for beam 313.

Mirror 318 is disposed in and rotates with tip portion 206 on axis 308. Preferably, mirror 318 is disposed near an end of tip portion 206 farthest from body portion 204. Mirror 318 may be a separate reflector attached to probe tip 206, and may be a cut and polished glass rod with a diameter of about 2 to 3 mm. However, other types, shapes and diameters of mirror 318 may be used without departing from the scope of the present disclosure. Mirror 318 is angled to deflect laser beam 312 perpendicular to inner surface 9 of workpiece 7. In the example provided, mirror 318 is generally angled at 45 degrees with respect to axis 108. However, it should be appreciated that mirror 318 may have other angles with respect to axis 308, such as when inspection of a conical surface is desired, without departing from the scope of the present disclosure.

Glass spacer 324 is disposed adjacent polarizing beam splitter 314 in the path of return beam 313. However, in an alternative embodiment, glass spacer 324 is omitted. In another alternative embodiment, glass spacer 324 may be replaced with an opaque spacer with an aperture at its center to permit the return beam to pass through to detector 332. Right angle prism 326 is disposed adjacent to glass spacer 324 and in the path of return beam 313 after return beam 313 has been deflected by polarizing beam splitter 314. Right angle prism 326 is oriented to deflect return beam 313 in a direction substantially parallel to axis 308. In an alternative embodiment, glass spacer 324 and right angle prism 326 are omitted. Such an alternative embodiment may be desirable because the spatial constraints on the location of the optical components are more relaxed than are the spatial constraints in an embodiment with a rotating probe body.

In the example provided, wavelength filter 328 and neutral density filter 330 are disposed adjacent right angle prism 326. However, in an alternative embodiment, neutral density filter 330 is omitted, and wavelength filter 328 is omitted when the only potential source of light reaching detector 332 is generated by laser 310.

In the example provided, polarizing beam splitter 314, quarter wave plate 316, glass spacer 324, and right angle prism 326 are held rigid by an index matching epoxy. However, the components may be held rigid in other ways without departing from the scope of the present disclosure. Preferably, any optical surface in contact with air is coated to reduce reflection.

Detector 332 is disposed adjacent neutral density filter 330 in the path of return beam 313. It should be appreciated that detector 332 is disposed in the alternative path of return beam 313 when right angle prism 326 and glass spacer 324 are omitted. Detector 332 is generally a photodiode that converts optical signals to electrical signals. However, other types of detectors 332 may be used without departing from the scope of the present disclosure.

Electrical cable 334 connects detector 332 with electronic circuit 336 and cable 338 transmits data from electronic circuit 336 to computer 28.

With continued reference to FIG. 3, the operation of inspection system 200 will now be described. During operation, rotation machine 220 will spin rotatable shaft 218 which spins probe tip 206 as linear movement machine 223 linearly moves base 202 so that probe tip 206 enters bore 12. For a smooth cylindrical inner surface 9, much of laser beam 312 will be reflected directly back on itself as return beam 313. If a surface defect 13 is present, at least some of laser beam 312 will scatter and not be reflected as return beam 313. Thus, the intensity of return beam 313 as a function of position of the laser spot on surface 9 may be used to indicate the presence of surface defect 13.

Laser beam 312 is emitted by laser 310 through polarizing beam splitter 314, quarter wave plate 316, beam reducer 317, aperture 225 in rotary encoder 222, aperture 219 in rotatable shaft 218, and probe tip 206 and is redirected towards inner surface 9 of workpiece 7 by mirror 318. Upon reaching inner surface 9, part of laser beam 312 is back reflected along the path of incident laser beam 312. If surface defect 13 is present, at least part of laser beam 312 will not be reflected as return beam 313. When at least part of laser beam 312 does not reflect back, any return beam 313 that does return will have lower intensity than when there is no surface defect 13. Return beam 313 is reflected by mirror 318 through probe tip 206, aperture 219 in rotatable shaft 218, aperture 225 in rotary encoder 222, and beam reducer 317 (which now may act as a beam expander) towards quarter wave plate 316. Quarter wave plate 316 converts return beam 313 polarization so that polarizing beam splitter 314 redirects return beam 313 through spacer 324 to right angle prism 326. Right angle prism 326 directs return beam 313 through wavelength filter 328 and neutral density filter 330 to detector 332. When employed, neutral density filter 330 reduces return beam 313 intensity to prevent saturation of the electronic circuit 336 or data acquisition unit 26, and wavelength filter 328 reduces the intensity of the return light corresponding to certain wavelengths. Detector 332 converts the intensity of return beam 313 into an electrical signal and sends the electrical signal through electrical cable 334 to electronic circuit 336. Electronic circuit 336 sends a signal indicative of the intensity of return beam 313 through cable 338.

Data from probe 210 is transmitted through cable 338 to data acquisition unit 26 in computer 28. Data from rotary encoder 222 is also sent to data acquisition unit 26. When a pulse is received from rotary encoder 222, data acquisition unit 26 samples the value of the signal from probe 210. Data from linear encoder 224 may also be sent to data acquisition unit 26 to indicate the axial location at which data from probe 10 is being sampled.

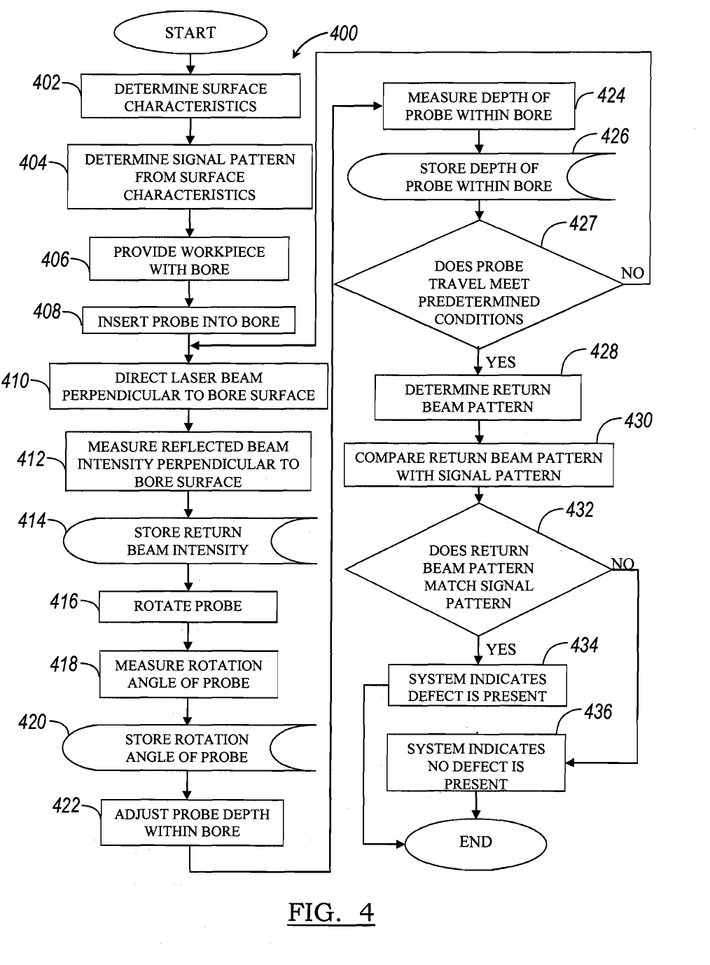

Referring now to FIG. 4, with continued reference to FIGS. 2 and 3, a method of inspecting bore 12 using probe 10 is described and is generally indicated by reference number 400. Starting in block 402, acceptable characteristics and characteristics of defects of inner surface 9 within bore 12 are determined. Defect characteristics may indicate the type and size of defect and size of defects 13 on inner surface 9, a surface roughness parameter of the surface or geometric information about the cylinder. However, other characteristics may be used in block 402. Acceptable characteristics may be the same or similar indicators having different sizes, numbers, parameters, or geometries. In the example provided, defect characteristics are determined and used through the method. However, acceptable characteristics or both acceptable characteristics and defect characteristics may be used.

In block 404, signal patterns, including intensity thresholds, corresponding to defects or surface patterns indicative of surface defects from block 402 are determined.

In block 406, a workpiece 7 including bore 12 with inner surface 9 is provided and probe 10 is inserted into bore 12 in block 408. In block 410, scanning begins by directing laser beam 112 perpendicular to inner surface 9 of bore 12. The intensity of return beam 113 that reflects perpendicular to inner surface 9 of bore 12 is measured in block 412 and is stored in block 414. In the example provided, the intensity values of sampled points of return beam 113 are stored as a data file.

In block 416, the probe is rotated within bore 12. The angle of rotation of probe 10 within bore 12 is measured in block 418 and is stored in block 420. In block 422, the depth of probe 10 within bore 12 is adjusted. The depth of probe 10 within bore 12 is measured in block 424 and is stored in block 426. In the example provided, blocks 416 to 420 and 422 to 426 are performed simultaneously with blocks 410 to 414. However, blocks 416 to 420 and 422 to 426 may be performed separately from each other and from blocks 410 to 414 without departing from the scope of the present disclosure.

In decision block 427, it is determined whether the travel of probe 10 within bore 12 has met predetermined conditions for the amount of bore 12 to be scanned. In the example provided, the predetermined conditions are selected to correspond to scanning the entire length of bore 12. However, the predetermined conditions may be selected to correspond to scanning less than the entire length of bore 12. If the predetermined conditions are not met, the method returns to block 410 where scanning will continue. If the predetermined conditions have been met, the method proceeds to block 428.

In an example of steps 410 to 427, probe 10 is rotated in a low pitch screw path to scan the surface of the cylinder with laser beam 112 directed perpendicular to the inner surface 9 of bore 12. Positioning machine 20 moves probe 10 towards the starting position of the scan in or near bore 12. When probe 10 has reached the starting position linear encoder 24 sends a signal to the CNC control program. After receiving the signal from linear encoder 24, the CNC control program begins spinning probe 10. Rotary encoder 22 sends different signals to data acquisition unit 26 at different intervals. Index signals are sent at index intervals corresponding to a certain angular orientation of probe 10. Sample signals are recorded at intervals predetermined from the rotary orientation of probe 10 and fixed in number during every full rotation of probe 10. When the probe begins to spin, data acquisition unit 26 looks for the next index signal from rotary encoder 22 and begins sampling data after receiving the index signal. Data acquisition unit 26 takes and stores samples of continuously streaming data from detector 132 at every sample signal pulse from rotary encoder 22 until a predetermined number of pulses that indicate a full scan have been received. Computer 28 calculates the angle for each data point from the angle at which the index pulse is emitted, the known number of pulses per revolution and the order of a particular sample in the stored data file. However, it should be understood that the method of taking data from probe 10 may take other forms without departing from the scope of the present invention.

In block 428, a return beam pattern is determined from the intensity of return beam from block 414, the probe angle from block 420, and the depth of probe 10 within bore 12 from block 422. In block 430, the return beam pattern is compared with the signal patterns determined in block 404 and it is determined whether the return beam pattern matches the signal pattern in decision block 432. In the example provided, if the return beam pattern matches the threshold for the signal pattern of a defect then a defect has been detected and inspection system 5 indicates that the defect is present in block 434. The workpiece 7 will be removed from the production line for further inspection. If the return beam pattern does not match the threshold for the signal pattern of a defect then no defect is detected and inspection system 5 indicates that the defect is not present in block 436. The workpiece 7 will continue as part of the production stream and the method is complete. It should be appreciated that blocks 428 to 430 may be performed before the predetermined conditions of block 427 have been met, and the scan may be interrupted if a defect is detected. Of course, the present invention contemplates that method 400 may be repeated to inspect other surfaces or other parts.

In additional steps, even when no individual signal pattern meets the threshold for a defect, the recorded signal patterns of different inspected components may be compared to determine whether variations in signal patterns are changing monotonically over time. If the signal pattern variations are changing monotonically then the computer may generate a message to indicate a drift in the production stream that may eventually result in defects on production parts. Detecting this drift can enable corrections to the production process to be made before a defect is actually generated, thus preventing the production of defective parts.

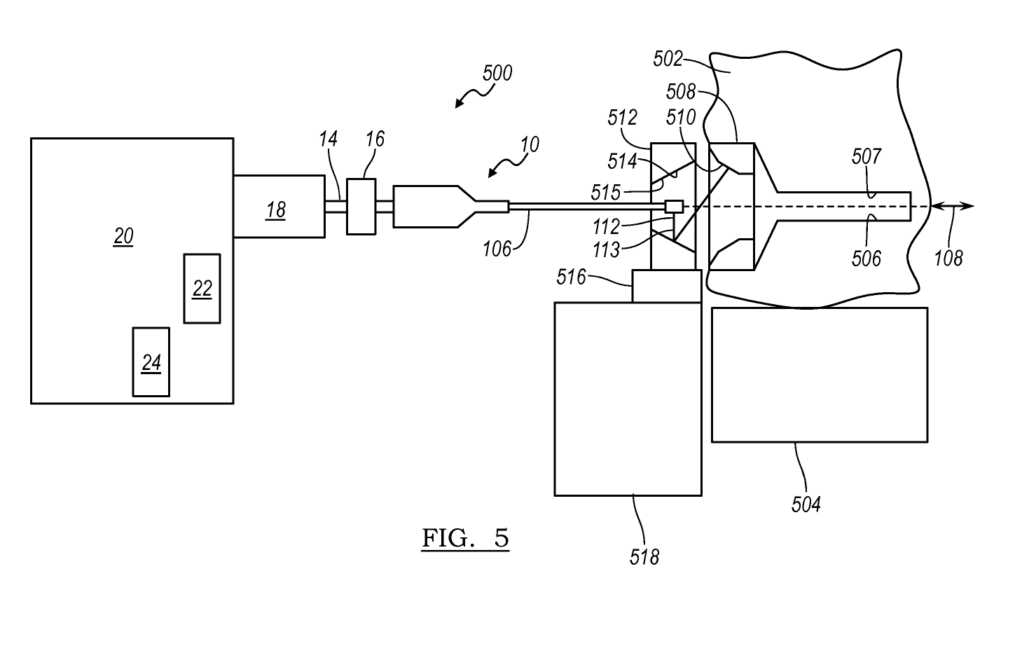

With reference now to FIG. 5, a schematic diagram of inspection system 500 for inspecting workpiece 502 is shown. Inspection system 500 includes probe 10, probe shaft 14, slip ring 16, rotatable shaft 18, positioning machine 20, rotary encoder 22, and linear encoder 24.

Workpiece 502 is mounted on part positioning fixture 504 and includes an at least partially reflective inner surface 506 that circumscribes axis 108 and defines at least one bore 507. Workpiece 502 also includes a conical portion or conical member 508 having an angled surface 510 that is at an angle different from the angle of the inner surface 506. In the example provided, workpiece 502 is an engine head of an internal combustion engine, bore 507 is a valve guide, and conical member 508 is a valve seat. However, it should be appreciated that other types of bores and conical surfaces within other types of workpieces may be inspected by inspection system 500.

Inspection system 500 further includes a conical mirror 512 having a conical mirror surface 514 circumscribing axis 108. Conical mirror surface 514 defines a bore 515 that accommodates probe tip 106 of probe 10 as probe 10 moves along axis 108 during inspection. The angle of conical mirror surface 514 is selected to direct laser beam 112 from probe 10 perpendicular to angled surface 510 of conical member 508. Conical mirror 512 is fixed to a mirror mounting and positioning fixture 516 which is attached to fixed platform 518. In the example provided, fixed platform 518 does not move along axis 108.

With continued reference to FIG. 5, the operation of inspection system 500 will now be described. Laser beam 112 exits probe 10 perpendicular to axis 108 and then reflects off of conical mirror surface 514 of conical mirror 512 towards and perpendicular to angled surface 510 of conical member 508. When laser beam 112 reaches the angled surface 510 of conical member 508, at least a portion of laser beam 112 reflects back towards conical mirror 512 as return beam 113. Return beam 113 then reflects off of conical mirror surface 514 towards probe 10, where the intensity of return beam 113 and the alignment of conical member 508 relative to axis 108 are determined. In the example provided, after inspecting angled surface 510 of conical member 508, probe 10 continues moving axially through conical mirror 512 into bore 507 where probe 10 inspects the alignment of bore 507 relative to the axis 108. Using the measurements from conical member 508 and bore 507, probe 10 determines whether conical surface 510 is concentric with bore 507 of workpiece 502.

In an alternative embodiment for determining whether a conical surface and a cylindrical surface are concentric, a first probe has a first mirror angled to inspect the conical surface of a valve seat and a second probe with a second mirror angled at 45° to inspect a valve guide hole. The first and second probes may be sequentially moved to the same measurement position relative to the valve guide to inspect both the valve seat and the valve guide hole.

The present invention has many advantages over the prior art. A probe according to the present disclosure may scan the entire inner surface of bores having varying diameters. The probe may complete the inspection rapidly enough to be used on a production line.

While the preferred modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. A non-contact probe for inspecting a surface by emitting a light beam towards the surface and receiving a return beam consisting of at least a portion of at least one of a directly back-scattered light and a back-reflected light from the surface, the non-contact probe comprising:
a probe body;
a probe tip that extends away from the probe body and defines an axis;
a light source disposed in the probe body, wherein the light source is oriented to direct the light beam along the axis of the probe tip;
a light directing member disposed in the probe tip, wherein the light directing member deflects the emitted light beam away from the axis and deflects at least a portion of the return beam back along the axis through the probe tip;
a light splitter disposed in the probe body and positioned to receive the emitted light beam and the return beam, wherein the light splitter is configured to separate the return beam from the emitted light beam; and
a light detector disposed in the probe body and positioned to receive the return beam, wherein the light detector receives at least a portion of the return beam and provides a signal that indicates an intensity of the return beam.

2. The non-contact probe of claim 1 wherein the light directing member is a mirror.

3. The non-contact probe of claim 1 wherein the probe tip has a predetermined length and a predetermined width, wherein the predetermined length is selected to be greater than a depth of a predetermined feature to be measured in a predetermined workpiece and the predetermined width is selected to be less than a width of the feature.

4. The non-contact probe of claim 3 wherein the feature is one of a cylindrical surface and a conical surface.

5. The non-contact probe of claim 3 wherein the feature is one of a valve port of a valve body of an automatic transmission, a brake cylinder, a shock absorber, a hydraulic cylinder, a pneumatic cylinder, a gas flow valve, a cylinder with a structured internal surface, and a valve seat of an engine head.

6. The non-contact probe of claim 1 wherein the light directing member deflects the light beam perpendicular to the surface that is to be inspected.

7. The non-contact probe of claim 1 wherein the probe body and the probe tip define a common axis.

8. The non-contact probe of claim 1 further including an optical filter disposed in a path of the beam.

9. The non-contact probe of claim 1 further including a beam reducer disposed in the probe body to reduce a diameter of the emitted light beam.

10. The non-contact probe of claim 1 wherein the light splitter includes a polarizing beam splitter and a quarter wave plate.

11. The non-contact probe of claim 1 wherein the light source is a laser source and the light beam is a laser beam.

12. An inspection system for inspecting a surface of a workpiece by emitting a light beam towards the surface and receiving a return beam consisting of at least a portion of at least one of a directly back-scattered light and a back-reflected light from the surface, the inspection system comprising:
a positioning machine that is translatable into a plurality of axial positions;
a rotatable member that is rotatable into a plurality of angular positions;
at least one position encoder that provides a position signal indicative of at least one of the axial position of the positioning machine and the angular position of the rotatable member;
a probe body;
a probe tip axially coupled with the positioning machine, wherein the probe tip extends away from the probe body and defines an axis;
a light source disposed in the probe body, wherein the light source is oriented to direct the light beam along the axis of the probe tip;
a light directing member disposed in the probe tip, wherein the light directing member deflects the emitted light beam away from the axis and deflects at least a portion of the return beam along the axis through the probe tip;
a light splitter disposed in the probe body and positioned to receive the emitted light beam and the return beam, wherein the light splitter is configured to separate the return beam from the emitted light beam;
a light detector disposed in the probe body and positioned to receive the return beam, wherein the light detector receives at least a portion of the return beam and provides a signal that indicates an intensity of the return beam; and
an electronic device in electronic communication with the light detector and the at least one position encoder, the electronic device including a first control logic that records the intensity signal and the position signal and a second control logic that compares the intensity and position signals with a predetermined pattern to determine a characteristic of the surface, and
wherein at least one of the probe body and the probe tip is rotatably coupled with the rotatable member.

13. The inspection system of claim 12 wherein the electronic device includes a third control logic that maps the signal of the light detector to the axial position of the positioning machine and the angular position of the rotatable member to determine a signal intensity map of the surface.

14. The inspection system of claim 13 wherein the electronic device includes a fourth control logic that compares the signal intensity map with at least one predetermined signal intensity map to indicate whether a defect is present on the surface.

15. The inspection system of claim 12 wherein the surface is one of an inside surface of a valve port of a valve body or pump cover of an automatic transmission, an inside surface of a brake cylinder, an inside surface of a cylindrical component of a shock absorber, an inside surface of a hydraulic cylinder, an inside or outside surface of a cylindrical manufactured part, a surface of a valve seat of an engine head, and an inside surface of an internally threaded cylindrical part.

16. The inspection system of claim 12 further including an electronic communication device to provide electrical communication between the probe and an inspection station.

17. The inspection system of claim 16 wherein the probe body is rotatably mounted to the rotatable member and the electronic communication device is a slip ring.

18. The inspection system of claim 12 further comprising a base plate mounted on the positioning machine, wherein the probe body and the rotatable member are mounted on the base plate, wherein the rotatable member includes a hollow rotating shaft through which the emitted light beam is directed, wherein the rotatable member is disposed substantially between the probe tip and the probe body, and wherein the probe tip is rotatably coupled with the hollow rotating shaft.

19. The inspection system of claim 12 wherein the rotatable member is a spindle.

20. A method of inspecting a surface of a workpiece, the method comprising:
directing a light beam from a light source along an axis of a probe tip that extends away from a probe body, wherein the light beam is disposed in the probe body;
deflecting the light beam away from the axis of the probe tip with a light directing member disposed in the probe tip;
deflecting at least a portion of a return beam along the axis of the probe tip with the light directing member disposed in the probe tip, wherein the return beam comprises at least a portion of at least one of a directly back-scattered light and a back-reflected light from the surface;
splitting the return beam from the emitted beam with a light splitter disposed in the probe body;
detecting an intensity of the return beam with a light detector disposed in the probe body;
providing an intensity signal from the light detector that indicates the intensity of the return beam;
recording the intensity signal with an electronic device;
rotating the probe tip with a rotatable member that is rotatably coupled with the probe tip and rotatable into a plurality of positions;
translating the probe with a positioning machine that is axially coupled with the probe tip and translatable into a plurality of axial positions;
detecting at least one of the angular position of the rotatable member and the axial position of the positioning machine with at least one position encoder;
providing at least one position signal from the at least one position encoder that indicates at least one of the angular position of the rotatable member and the axial position of the positioning machine with at least one position encoder;
recording the at least one position signal with the electronic device; and
comparing the intensity and position signals with a predetermined pattern to determine a characteristic of the surface.
